(19) United States
(12) Patent Application Publication
(10) Pub. No.: US 2023/0315118 A1
(43) Pub. Date: Oct. 5, 2023

(54) INFORMATION PROCESSING METHOD, INFORMATION PROCESSING DEVICE, AND PROGRAM

(71) Applicant: MITSUBISHI HEAVY INDUSTRIES, LTD., Tokyo (JP)

(72) Inventors: Atsuyoshi SAIMEN, Tokyo (JP); Kenji TAKAO, Tokyo (JP)

(73) Assignee: MITSUBISHI HEAVY INDUSTRIES, LTD., Tokyo (JP)

(21) Appl. No.: 18/121,265

(22) Filed: Mar. 14, 2023

(30) Foreign Application Priority Data
Mar. 30, 2022 (JP) 2022-057291

(51) Int. Cl. G05D 1/02

(52) U.S. Cl. CPC G05D 1/0225; G05D 1/0287

(57) ABSTRACT

An information processing method includes acquiring information on a charge amount of a mobile body, acquiring information on a scheduled work that is a work scheduled to be done, and setting a next work of the mobile body based on the information on the charge amount and the information on the scheduled work.

### CROSS-REFERENCE TO RELATED APPLICATIONS

This application claims the benefit of priority to Japanese Patent Application Number 2022-057291 filed on Mar. 30, 2022. The entire contents of the above-identified application are hereby incorporated by reference.

### TECHNICAL FIELD

The disclosure relates to an information processing method, an information processing device, and a program.

### RELATED ART

There is a known technology for managing a plurality of mobile bodies that move automatically. For example, JP 2021-35327 A describes that, when a charge amount of an electric vehicle falls below a prescribed threshold value, the electric vehicle stops traveling and proceeds to charging.

### SUMMARY

However, for example, in a case where a mobile body proceeds to charging even when power consumption in the next work is small, or in a case where a plurality of mobile bodies proceeds to charging during the same time period, there is a concern that the operating ratio of the mobile body may be reduced due to a time required for charging, and the like. Therefore, there is a need for suppressing a reduction in the operating ratio of the mobile body.

The disclosure has been made to solve the above-described problem, and an object of the disclosure is to provide an information processing method, an information processing device, and a program that can suppress the reduction in the operating ratio of a mobile body.

An information processing method according to the disclosure includes acquiring information on a charge amount of a mobile body, acquiring information on a scheduled work that is a work scheduled to be done, and setting a next work of the mobile body based on information on the charge amount and the information on the scheduled work.

An information processing device according to the disclosure includes a charge amount acquisition unit configured to acquire information on a charge amount of a mobile body, a scheduled work acquisition unit configured to acquire information on a scheduled work that is a work scheduled to be done, and a work setting unit configured to set a next work of the mobile body based on the information on the charge amount and the information on the scheduled work.

A program according to the disclosure causes a computer to perform processing, the processing including acquiring information on a charge amount of a mobile body, acquiring information on a scheduled work that is a work scheduled to be done, and setting a next work of the mobile body based on the information on the charge amount and the information on the scheduled work.

According to the disclosure, the reduction in the operating ratio of a mobile body can be suppressed.

### BRIEF DESCRIPTION OF DRAWINGS

The disclosure will be described with reference to the accompanying drawings, wherein like numbers reference like elements.

FIG. 1 is a schematic view of a movement control system according to the present embodiment.

FIG. 2 is a schematic view of a configuration of a mobile body.

FIG. 3 is a schematic block diagram of a management device.

FIG. 4 is a schematic block diagram of an information processing device.

FIG. 5 is a schematic block diagram of a control device for the mobile body.

FIG. 6 is a table showing an example of movement destination information.

FIG. 7 is a table for illustrating the setting of a work.

FIG. 8 is a table illustrating an example in which estimated power consumption is set in advance.

FIG. 9 is a flowchart illustrating a flow for setting a next work according to a first embodiment.

FIG. 10 is a table illustrating an example of setting a next work according to a second embodiment.

FIG. 11 is a schematic view illustrating an example of dropping a target object at an intermediate position.

FIG. 12 is a schematic view illustrating an example of dropping a target object at an intermediate position.

FIG. 13 is a table illustrating an example of setting a reference threshold value.

### DESCRIPTION OF EMBODIMENTS

Hereinafter, preferred embodiments of the disclosure will be described in detail with reference to the accompanying drawings. Note that the disclosure is not limited to these embodiments, and when there are a plurality of embodiments, the disclosure is intended to include a configuration combining these embodiments.

### First Embodiment

### Movement Control System

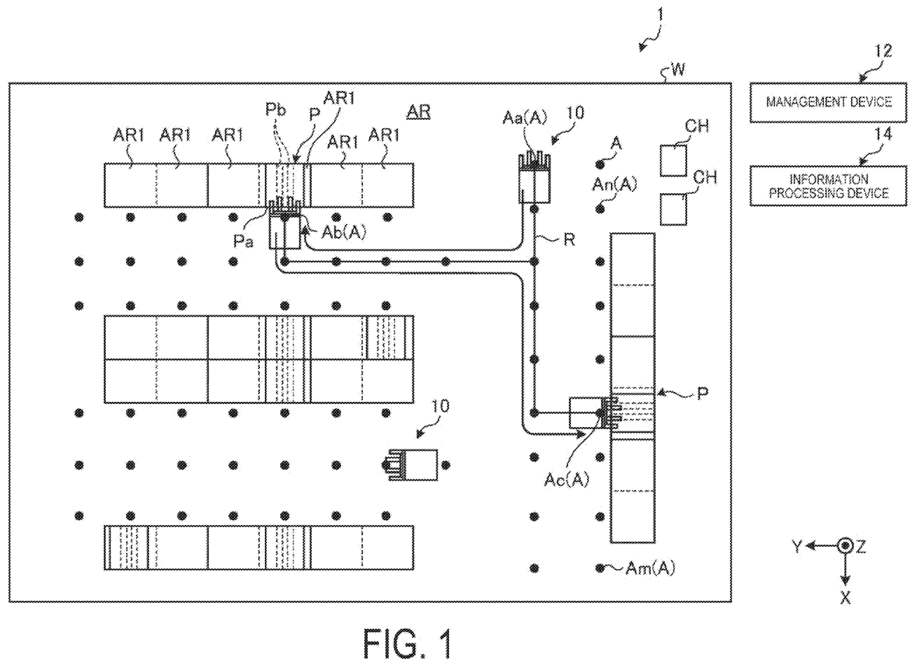

FIG. 1 is a schematic view of a movement control system according to the present embodiment. As illustrated in FIG. 1, a movement control system 1 according to the present embodiment includes a mobile body 10, a management device 12, and an information processing device 14. The movement control system 1 is a system that controls the movement of the mobile body 10 belonging to a facility W. The facility W is a facility, such as a warehouse, that is logistically managed. The movement control system 1 causes the mobile body 10 to pick up and convey a target object P disposed within an area AR in the facility W. The area AR is, for example, a floor surface of the facility W, and is an area in which the target object P is placed and through which the mobile body 10 moves. In the present embodiment, the target object P is a conveyance target object composed of a pallet and a burden loaded on the pallet. The target object P includes an opening Pb into which a fork 24 of the mobile body 10 to be described later is inserted, and the opening Pb is formed in a front surface Pa of the target object P. However, the target object P is not limited to an object composed of a pallet and a burden loaded on the pallet, and may be only a burden without a pallet, for example.

Hereinafter, an operation including movement along a route R (to be described later) by the mobile body 10 will be appropriately referred to as a work of the mobile body 10. Further, in the present embodiment, the mobile body 10 moves along the route R to load, convey, and unload the target object P, and thus a series of operations by the mobile body 10 to move along the route R, and load, convey, and unload the target object P can be said to be the work of the mobile body 10. Hereinafter, one direction along the area AR is referred to as an X direction, and a direction along the area AR that is orthogonal to the X direction is referred to as a Y direction. In the present embodiment, the Y direction is a direction orthogonal to the X direction. The X direction and the Y direction may be horizontal directions. A direction orthogonal to the X direction and the Y direction, more specifically, an upward direction in the vertical direction is referred to as a Z direction. In the present embodiment, unless otherwise specified, a “position” refers to a position (coordinates) in a coordinate system in a two dimensional plane on the area AR (the coordinate system of the area AR). Also, unless otherwise specified, an “orientation” of the mobile body 10 or the like refers to an orientation of the mobile body 10 in the coordinate system of the area AR, and means a yaw angle (rotation angle) of the mobile body 10 with the X direction defined as 0 degrees when viewed from the Z direction.

### Placement Area

A plurality of placement areas AR1 is disposed in the area AR in the facility W. The placement areas AR1 are configured to be used as areas in which the target object P is placed. The target object P may be placed or may not be placed in each placement area AR1 depending on the situation of the facility W. The position (coordinates), the shape, and the size of the placement area AR1 are determined in advance. In the example illustrated in FIG. 1, the placement areas AR1 are set on a shelf provided in the area AR, but are not limited thereto, and may be provided on the area AR (i.e., on the floor of the facility W), or may be provided in a loading platform of a vehicle that has conveyed the target object P into the facility W. In addition, in the present embodiment, the placement area AR1 is defined for each target object P, and one target object P is placed in each placement area AR1, but the disclosure is not limited thereto. For example, the placement area AR1 may be set as a free space in which a plurality of target objects P are placed. In addition, in the example in FIG. 1, the placement area AR1 has a rectangular shape, but may have any shape and any size, and the number of the placement areas AR1 is also optional.

### Waypoint

In the area AR, a waypoint A is set for each position (coordinates). The route R along which the mobile body 10 moves is configured to connect the waypoints A. That is, a route connecting the waypoints A through which the mobile body 10 is scheduled to pass is the route R of the mobile body 10. The waypoints A are set according to the layout of the facility W such as the positions of the placement areas AR1 and passages. For example, the waypoints A are set in a matrix form in the area AR, and the positions and the number of the waypoints A are set such that a route R connecting a position facing one placement area AR1 to a position facing another arbitrary placement area AR1 can be set. The position facing the placement area AR1 may be, for example, a position at which the mobile body 10 can pick up the target object P placed in the placement area AR1. In addition, the waypoints A include a waypoint A configured to be a charging point (in the example of FIG. 1, a waypoint An at which a charger CH is placed) or a waypoint A configured to be a waiting point (in the example of FIG. 1, a waypoint Am). The waypoint A that is a charging point or a waiting point may be set at any position that does not overlap with a route (the route used for conveyance) connecting the waypoints A facing the respective placement areas AR1.

### Mobile Body

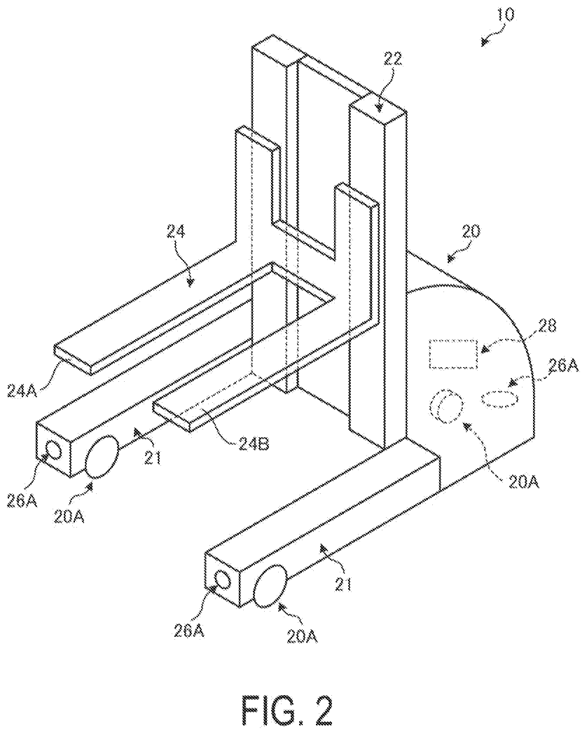

FIG. 2 is a schematic view of a configuration of a mobile body. The mobile body 10 is a device that can move automatically and convey the target object P. Further, in the present embodiment, the mobile body 10 is a forklift, and more specifically, a so-called automated guided vehicle (AGV) or a so-called automated guided forklift (AGF). However, the mobile body 10 is not limited to a forklift for conveying the target object P, and may be any device capable of moving automatically.

As illustrated in FIG. 2, the mobile body 10 includes a vehicle body 20, a wheel 20A, a straddle leg 21, a mast 22, a fork 24, a sensor 26A, and a control device 28. The straddle leg 21 is a shaft-like member that is disposed in pairs at one end portion of the vehicle body 20 in a front-back direction and protrudes from the vehicle body 20. The wheel 20A is disposed at a leading end of each of the straddle legs 21 and at the vehicle body 20. That is, a total of three wheels 20A are disposed, but the positions and the number of the wheels 20A disposed may be arbitrary. The mast 22 is movably attached to the straddle legs 21 and moves in the front-back direction of the vehicle body 20. The mast 22 extends along the vertical direction (here, the direction Z) orthogonal to the front-back direction. The fork 24 is attached to the mast 22 so as to be movable in the direction Z. The fork 24 may be movable in a lateral direction of the vehicle body 20 (a direction intersecting with the vertical direction and the front-back direction) with respect to the mast 22. The fork 24 includes a pair of tines 24A and 24B. The tines 24A and 24B extend, from the mast 22, toward the front direction of the vehicle body 20. The tines 24A and 24B are arranged separated from each other in the lateral direction of the mast 22. In the front-back direction, a direction to a side of the mobile body 10 where the fork 24 is disposed and a direction to a side where the fork 24 is not disposed are referred to as a front direction and a back direction, respectively.

The sensors 26A detect at least one of the position and the orientation of a target object present in the periphery of the vehicle body 20. That is, it can be said that the sensor 26A detects at least one of the position of the target object relative to the mobile body 10 and the orientation of the target object relative to the mobile body 10. In the present embodiment, the sensor 26A is disposed at a leading end of each of the straddle legs 21 in the front direction, and at the vehicle body 20 on a back direction side. However, the positions at which the sensors 26A are disposed are not limited thereto, and the sensors 26A may be disposed at any positions, and the number of the sensors 26A disposed may be arbitrary.

The sensor 26A is a sensor that emits a laser beam, for example. The sensor 26A emits the laser beam while performing scanning in one direction (here, the lateral direction), and detects the position and the orientation of the target object based on the reflected light of the laser beam emitted. That is, the sensor 26A is a so-called two-dimensional (2D) light detection and ranging (LiDAR) sensor. Note that the sensor 26A is not limited to the one described above and may be a sensor that detects the target object using any method, such as a so-called three-dimensional (3D)-LiDAR in which scanning is performed in multiple directions, or may be a so-called one dimensional (1D)-LiDAR in which no scanning is performed, or may be a camera.

The control device 28 controls the movement of the mobile body 10. The control device 28 will be described later.

### Management Device

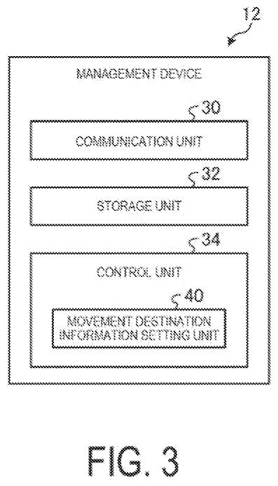

FIG. 3 is a schematic block diagram of a management device. The management device 12 is a system that manages physical distribution in the facility W. The management device 12 is a warehouse control system (WCS) or a warehouse management system (WMS) in the present embodiment, but is not limited to a WCS and a WMS, and may be any system including a backend system such as any other production management system. The management device 12 may be disposed at any position, and may be disposed in the facility W, or may be disposed at a separate position from the facility W so as to manage the facility W from the separate position. The management device 12 is a computer and includes a communication unit 30, a storage unit 32, and a control unit 34 as illustrated in FIG. 3.

The communication unit 30 is a module used by the control unit 34 to communicate with an external device such as the information processing device 14, and may include, for example, a WiFi (registered trademark) module or an antenna. The communication method of the communication unit 30 is wireless communication in the present embodiment, but any communication method may be used. The storage unit 32 is a memory that stores various information such as computation contents of the control unit 34 and programs, and includes, for example, at least one of a primary storage device such as a random access memory (RAM) or a read only memory (ROM), and an external storage device such as a hard disk drive (HDD).

The control unit 34 is an arithmetic device and includes, for example, an arithmetic circuit such as a central processing unit (CPU). The control unit 34 includes a movement destination information setting unit 40. The control unit 34 reads a program (software) from the storage unit 32 and executes the program to implement the movement destination information setting unit 40 and perform the processing thereof. Note that the control unit 34 may execute such processing with a single CPU, or may include a plurality of CPUs and execute the processing with the plurality of CPUs. The movement destination information setting unit 40 may be implemented by a hardware circuit. The program for the control unit 34 stored in the storage unit 32 may be stored in a recording medium that is readable by the management device 12.

The movement destination information setting unit 40 sets movement destination information indicating a movement destination of the mobile body 10. The processing by the movement destination information setting unit 40 will be more specifically described later.

Note that the management device 12 may execute processing other than the setting of the movement destination information. For example, the management device 12 may also set information for controlling a mechanism other than the mobile body 10 disposed in the facility W (for example, an elevator and a door).

### Information Processing Device

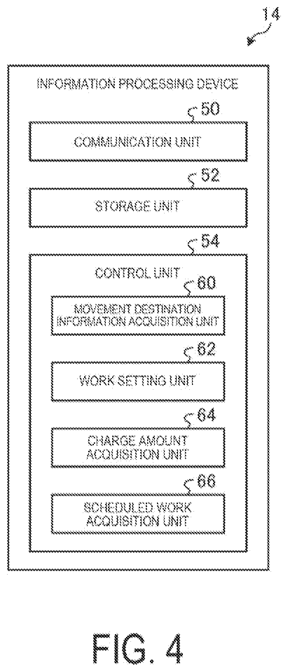

FIG. 4 is a schematic block diagram of the information processing device. The information processing device 14 is a device that is disposed in the facility W and processes information related to the movement of the mobile body 10. The information processing device 14 is, for example, a fleet control system (FCS), but is not limited thereto, and may be any device that processes information related to the movement of the mobile body 10. The information processing device 14 is a computer and includes a communication unit 50, a storage unit 52, and a control unit 54 as illustrated in FIG. 4. The communication unit 50 is a module used by the control unit 54 to communicate with an external device such as the management device 12 and the mobile body 10, and may include, for example, an antenna or a WiFi module. The communication method of the communication unit 50 is wireless communication in the present embodiment, but any communication method may be used. The storage unit 52 is a memory for storing various information such as computation contents of the control unit 54 and programs, and includes, for example, at least one of a primary storage device such as a RAM or a ROM, and an external storage device such as an HDD.

The control unit 54 is an arithmetic device and includes an arithmetic circuit such as a CPU, for example. The control unit 54 includes a movement destination information acquisition unit 60, a work setting unit 62, a charge amount acquisition unit 64, and a scheduled work acquisition unit 66. The control unit 54 reads programs (software) from the storage unit 52 and executes the programs to implement the movement destination information acquisition unit 60, the work setting unit 62, the charge amount acquisition unit 64, and the scheduled work acquisition unit 66 and perform the processing thereof. Note that the control unit 54 may execute such processing with a single CPU or may include a plurality of CPUs and execute the processing with the plurality of CPUs. At least a part of the movement destination information acquisition unit 60, the work setting unit 62, the charge amount acquisition unit 64, and the scheduled work acquisition unit 66 may be implemented by a hardware circuit. The program for the control unit 54 stored in the storage unit 52 may be stored in a recording medium that is readable by the information processing device 14.

The movement destination information acquisition unit 60 acquires the movement destination information, the work setting unit 62 sets a work (including setting of a route R) for the mobile body 10 based on the movement destination information, the charge amount acquisition unit 64 acquires information on the charge amount of the mobile body 10, and the scheduled work acquisition unit 66 acquires information on a scheduled work that is a work of the mobile body 10 scheduled to be done. Specific contents of the above-described processing will be described later.

Note that, in the present embodiment, the management device 12 and the information processing device 14 are separate devices, but may be an integrated device. That is, the management device 12 may have at least a part of the function of the information processing device 14, and the information processing device 14 may have at least a part of the function of the management device 12.

### Control Device for Mobile Body

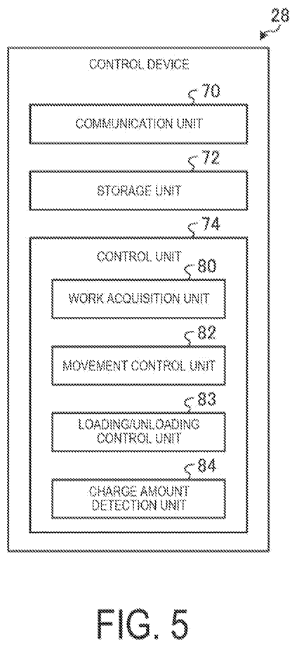

Next, the control device 28 for the mobile body 10 will be described. FIG. 5 is a schematic block diagram of a control device for the mobile body. The control device 28 is a device for controlling the mobile body 10. The control device 28 is a computer and includes a communication unit 70, a storage unit 72, and a control unit 74 as illustrated in FIG. 5. The communication unit 70 is a module used by the control unit 74 to communicate with an external device such as the information processing device 14, and may include, for example, an antenna or a WiFi module. The communication method of the communication unit 70 is wireless communication in the present embodiment, but any communication method may be used. The storage unit 72 is a memory for storing various information such as computation contents of the control unit 74 and programs, and includes, for example, at least one of a primary storage device such as a RAM or a ROM, and an external storage device such as an HDD.

The control unit 74 is an arithmetic device and includes an arithmetic circuit such as a CPU, for example. The control unit 74 includes a route acquisition unit 80, a movement control unit 82, a loading/unloading control unit 83, and a charge amount detection unit 84. The control unit 74 reads programs (software) from the storage unit 72 and executes the programs to implement the route acquisition unit 80, the movement control unit 82, the loading/unloading control unit 83, and the charge amount detection unit 84 and perform the processing thereof. Note that the control unit 74 may execute such processing with a single CPU or may include a plurality of CPUs and execute the processing with the plurality of CPUs. At least a part of the route acquisition unit 80, the movement control unit 82, the loading/unloading control unit 83, and the charge amount detection unit 84 may be implemented by a hardware circuit. In addition, the program for the control unit 74 stored in the storage unit 72 may be stored in a recording medium that is readable by the control device 28.

The route acquisition unit 80 acquires information indicating the route R of the mobile body 10, the movement control unit 82 controls a movement mechanism such as a drive unit or a steering device of the mobile body 10 so as to control the movement of the mobile body 10. The loading/unloading control unit 83 controls the fork 24 and the like to operate the fork 24 so as to control loading and unloading operation (operations of picking up and dropping a target object P). The charge amount detection unit 84 detects the charge amount (state of charge) of the mobile body 10. The charge amount here refers to the remaining amount of stored electric power of the mobile body 10. Specific contents of the above-described processing will be described later.

### Processing of Movement Control System

Next, the processing contents of the movement control system 1 will be described.

### Setting of Movement Destination Information

The movement destination information setting unit 40 of the management device 12 sets movement destination information indicating a movement destination of the mobile body 10. The movement destination information includes information indicating the position of the movement destination of the mobile body 10. More specifically, in the present embodiment, the movement destination information setting unit 40 sets the movement destination information so as to include first position information (position information of a first position) and second position information (position information of a second position). The first position is a position which the mobile body 10 reaches first, and the second position is a position which the mobile body 10 reaches next to the first position. That is, in the example of the present embodiment, the first position is the position of a conveyance source of the target object P, and the second position is the position of a conveyance destination of the target object P. The movement destination information setting unit 40 may directly specify the position (coordinates) of the first position as the first position information. In addition, an identifier may be assigned to each waypoint A. and the movement destination information setting unit 40 may specify the identifier of a waypoint A corresponding to the first position as the first position information. The same applies to the second position information.

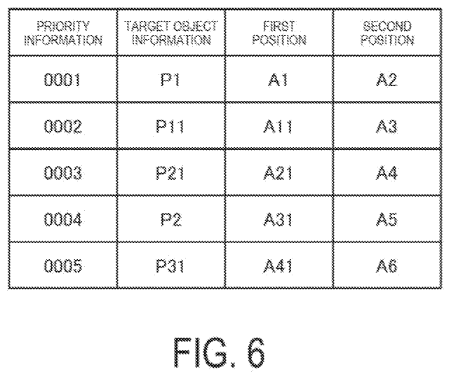

FIG. 6 is a table showing an example of movement destination information. In the present embodiment, the movement destination information setting unit 40 sets the movement destination information for each target object P to be conveyed, in other words, for each work. That is, the movement destination information setting unit 40 associates target object information indicating a target object P to be conveyed, the first position information that is the conveyance source of the target object P, and the second position information indicating the conveyance destination of the target object P with each other so as to set the movement destination information for each target object P. Note that, for example, an identifier may be assigned to each target object P, and information indicating the identifier may be used as the target object information. Further, as illustrated in FIG. 6, in the present embodiment, it is preferable for the movement destination information setting unit 40 to associate the target object information, the first position information, the second position information, and priority information with each other so as to set the movement destination information for each target object P. The priority information is information indicating a priority order for conveying a target object P among a group of movement destination information for each target object P. That is, for example, a target object P having the highest priority in the priority information is to be conveyed first. FIG. 6 shows an example in which pieces of movement destination information are set as follows: movement destination information in which the priority is 0001 (first), the target object is P1, the first position is A1, and the second position is A2; movement destination information in which the priority is 0002 (second), the target object is P11, the first position is A11, and the second position is A3; movement destination information in which the priority is 0003 (third), the target object is P21, the first position is A21, and the second position is A4; movement destination information in which the priority is 0004 (fourth), the target object is P2, the first position is A31, and the second position is A5; and movement destination information in which the priority is 0005 (fifth), the target object is P21, the first position is A41, and the second position is A6. However, FIG. 6 is only an example, and the movement destination information may be arbitrarily set in accordance with an order status or the like.

In addition, the movement destination information setting unit 40 may set the movement destination information so as to include designation information for designating a mobile body 10 to move from the first position to the second position (a mobile body 10 to perform the work). That is, in the example of the present embodiment, the movement destination information setting unit 40 may associate the target object information, the first position information, the second position information, the priority information, and the designation information with each other so as to set the movement destination information for each target object P. In that case, for example, an identifier may be assigned to each mobile body 10, and information indicating the identifier may be used as the designation information.

The movement destination information setting unit 40 may set the movement destination information in any method. For example, the movement destination information setting unit 40 may acquire an order information indicating a target object P to be conveyed, a conveyance source, and a conveyance destination, and set the movement destination information based on the order information. The movement destination information setting unit 40 transmits the set movement destination information to the information processing device 14 via the communication unit 30.

### Acquisition of Movement Destination Information

The movement destination information acquisition unit 60 of the information processing device 14 acquires the movement destination information from the management device 12 via the communication unit 50.

### Setting of Work

The work setting unit 62 of the information processing device 14 sets a work of the mobile body 10 based on the movement destination information. The work setting unit 62 sets the route R of the mobile body 10 to the movement destination as the work of the mobile body 10. In the present embodiment, the work setting unit 62 sets, as the route R of the mobile body 10, a first route to the first position (conveyance source) indicated by the first position information from an initial position at which the mobile body 10 is located immediately before starting to move to the first position, and a second route to the second position (conveyance destination) indicated by the second position information from the first position. That is, the work setting unit 62 sets the route R of the mobile body 10 such that respective waypoints A from the initial position to the first position are set as the first route, and respective waypoints A from the first position to the second position are set as the second route. In the example of FIG. 1, the movement destination information indicates that the first position is a waypoint Ab and the second position is a waypoint Ac, and the work setting unit 62 sets, as the route R of the mobile body 10, the first route passing through respective waypoints A from the waypoint Aa, which is the initial position of the mobile body 10 selected, to the waypoint Ab, and the second route passing through respective waypoints A from the waypoint Ab to the waypoint Ac.

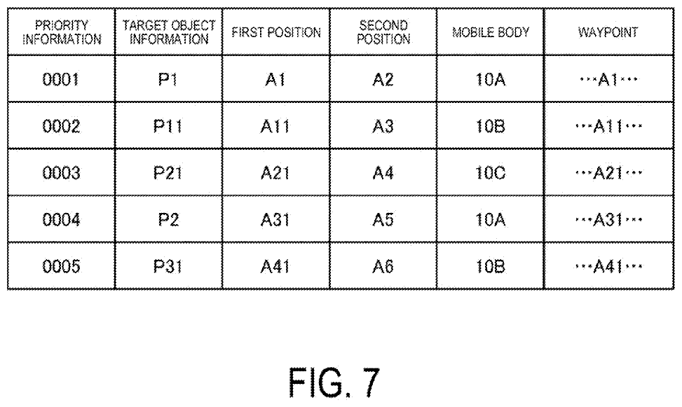

FIG. 7 is a table for explaining the setting of the work. When a plurality of mobile bodies 10 are deployed in the facility W, the work setting unit 62 selects a mobile body 10 that conveys a target object P as the work of the mobile body 10. Also, when the movement destination information is set for a plurality of target objects P, the work setting unit 62 sets the route R of a mobile body 10 for each target object P. That is, the work setting unit 62 selects, for each target object P, a mobile body 10 that conveys the target object P, and sets the route of the selected mobile body 10. In the example of FIG. 7, the work setting unit 62 selects a mobile body 10A as the mobile body 10 that conveys a target object P1 indicated by the movement destination information, and sets a route from the initial position of the mobile body 10A, through A1 as the first position, to A2 as the second position ( . . . waypoint A1 . . . ). Descriptions of mobile bodies selected for other target objects P illustrated in FIG. 7 and the routes (waypoints) thereof are the same as those above, and thus are omitted. Note that the work setting unit 62 may select a mobile body 10 in any manner, and may select a mobile body 10 for each target object P such that the time until the completion of the conveyance of all the target objects P is the shortest, for example. In the case where a target mobile body 10 has been designated as the designation information in the movement destination information, it is only necessary to select the mobile body 10 designated in the designation information.

The work setting unit 62 also sets a reserved time period during which the selected mobile body 10 passes through the route R (waypoints A) as the work of the mobile body 10. In this case, other mobile bodies 10 are prohibited from passing through the route R during the reserved time period. That is, the selected mobile body 10 occupies the set route R during the reserved time period. In setting the route R for each of a plurality of target objects P, the work setting unit 62 sets a mobile body 10, a route R (waypoints A), and a reserved time period for each target object P such that, in the reserved time period of one mobile body 10, the same waypoints A as those for the one mobile body 10 are not set for other mobile bodies (such that there is no overlapping of reserved time periods) and such that no deadlock occurs even when there is no overlapping of reserved time periods. Further, the work setting unit 62 may set a route R and a reserved time period also based on the priority information in the movement destination information. That is, the work setting unit 62 sets a mobile body 10, a route R. and a reserved time period for each target object P such that there is no overlapping of reserved time periods and that the conveyance of a target object P having a higher priority is completed sooner. Note that the route R includes a plurality of waypoints A, and thus the work setting unit 62 may set a reserved time period for each waypoint A included in the route R.

Note that the deadlock refers to a phenomenon in which each of a plurality of running programs or the like mutually waits for a result of other programs, and remains in a standby state and does not operate. In the present embodiment, the deadlock may refer to a phenomenon in which the mobile bodies 10 remain stopped if there is a possibility that the mobile bodies 10 will collide with each other when the mobile bodies 10 keep moving along the current routes, and if it is impossible to set avoidance routes toward travel direction sides.

The work setting unit 62 transmits information on the set work to the mobile body 10 to which the set work is assigned. In the example of FIG. 7, the work setting unit 62 transmits information on the work for the target object P1 and information on the work for the target object P2 to the mobile body 10A. The work setting unit 62 transmits information on the route R as the information on the work. The work setting unit 62 transmits information indicating respective waypoints A through which the route R passes as the information on the route R. For example, the work setting unit 62 may transmit position (coordinate) information of respective waypoints A through which the route R passes to the mobile body 10 as the information on the route R. or may transmit information indicating the identifiers of respective waypoints A through which the route R passes to the mobile body 10 as the information on the route R. Further, in the present embodiment, the work setting unit 62 also transmits information on the reserved time period, that is, information indicating the reserved time period during which the mobile body 10 passes through the route (waypoints A) to the mobile body 10 as the information on the work.

### Movement of Mobile Body

The route acquisition unit 80 of a mobile body 10 acquires information on the route R set for the mobile body 10 from the information processing device 14. The movement control unit 82 of the mobile body 10 moves the mobile body 10 along the route R acquired. In the present embodiment, the route acquisition unit 80 also acquires information on the reserved time period together with the information on the route R. The movement control unit 82 causes the mobile body 10 to pass through each waypoint A through which the route R passes during the reserved time period set for each waypoint A. The movement control unit 82 causes the mobile body 10 to move so as to pass through each waypoint A on the route R by sequentially grasping the position information of the mobile body 10. The method of acquiring the position information of the mobile body 10 is arbitrary. In the present embodiment, for example, a detection body (not illustrated) is provided in the facility W, and the movement control unit 82 acquires the information about the position and the orientation of the mobile body 10 based on the detection of the detection body. Specifically, the mobile body 10 irradiates the detection body with a laser beam, receives light of the laser beam reflected from the detection body, and detects the position and the orientation of the mobile body 10 in the facility W. The method of acquiring the information on the position and the orientation of the mobile body 10 is not limited to using a detection body, and simultaneous localization and mapping (SLAM) may be used, for example.

In the example of FIG. 1, the movement control unit 82 causes the mobile body 10 to move from the waypoint Aa, which is the initial position, to the waypoint Ab, which is the first position, so as to pass through each waypoint A from the waypoint Aa to the waypoint Ab. When the mobile body 10 reaches the waypoint Ab, the loading/unloading control unit 83 controls the fork 24 to insert the fork 24 into the opening Pb of the target object P placed in the placement area AR1 facing the waypoint Ab so as to pick up (load) the target object P. In this case, the movement control unit 82 may cause the sensor 26A to detect the position and the orientation of the target object P at the waypoint Ab or at any position before reaching the waypoint Ab. Then, the movement control unit 82 may set an approach route to the target object P based on the position and the orientation of the target object P, and approach the target object P along the approach route to pick up the target object P. That is, in that case, the movement control unit 82 may set a new approach route that allows a predetermined position and a predetermined orientation with respect to the position and the orientation of the target object P detected (the position and the orientation at which the mobile body 10 can pick up the target object P), and approach the target object P along the approach route. Alternatively, for example, the movement control unit 82 may cause the mobile body 10 to approach the target object P by performing feedback control (direct feedback control) based on the detection result of the position and the orientation of the target object P and the detection result of the position and the orientation of the mobile body 10. In that case, switching to the direct feedback control may be performed during the approach along a route based on the position and the orientation of the target object P.

After the mobile body 10 picks up the target object P, the movement control unit 82 causes the mobile body 10 to return to the waypoint Ab and then move to the waypoint Ac, which is the second position, so as to pass through each waypoint A from the waypoint Ab to the waypoint Ac. When the mobile body 10 reaches the waypoint Ac, the loading/unloading control unit 83 controls the fork 24 to drop (unload) the target object P in the placement area AR1 facing the waypoint Ac.

After the mobile body 10 drops the target object P, the movement control unit 82 causes the mobile body 10 to return to the waypoint Ac. When a next route R in which the waypoint Ac is the initial position is set in the information acquired by the route acquisition unit 80, the movement control unit 82 causes the mobile body 10 to move along the next route R.

### Setting Next Work Based on Charge Amount

Here, the mobile body 10 needs to be charged after consuming a certain amount of electrical power through the execution of a work. When it is determined that charging is necessary, the mobile body 10 moves to a charging point at which a charger CH (see FIG. 1) is installed, and is charged at the charging point. In the present embodiment, the information processing device 14 determines whether or not the mobile body 10 needs to be charged based on the charge amount of the mobile body 10 and the scheduled work that is a work scheduled to be done, and sets the next work of the mobile body 10. Hereinafter, a process of setting the next work of the mobile body 10 will be described. In the following, an example of setting the next work after the mobile body 10A conveys the target object P1 in FIG. 7 will be described.

### Acquisition of Charge Amount

The charge amount detection unit 84 of a mobile body 10 detects the charge amount of the mobile body 10. The charge amount detection unit 84 transmits information on the charge amount detected to the information processing device 14. The charge amount acquisition unit 64 of the information processing device 14 acquires the information on the charge amount of the mobile body 10 from the mobile body 10. In the present embodiment, the charge amount acquisition unit 64 acquires the charge amount of the mobile body 10 that has completed one work. In FIG. 7, for example, the charge amount acquisition unit 64 of the information processing device 14 acquires the charge amount of a mobile body 10A from the mobile body 10A in a state in which the mobile body 10A is located at a second position A2 after having dropped a target object P1 at the second position A2.

Charge Amount Equal to or Greater than Reference Threshold Value

Here, a charge amount threshold value is set for the mobile Body 10, where the charge amount threshold value is used for determining that charging is necessary. In the present embodiment, a reference threshold value and a limit threshold value that is smaller than the reference threshold value are set as the charge amount threshold value. The reference threshold value and the limit threshold value may be set arbitrarily, and, for example, may be set based on at least one of an environment of the facility W such as a temperature, a predicted value of power consumption with the number of times of charging considered, and a statistical error (for example, 3σ). The work setting unit 62 of the information processing device 14 sets the next work of the mobile body 10 based on the charge amount of the mobile body 10 and the reference threshold value. Specifically, when the charge amount of the mobile body 10 that has completed one work is equal to or greater than the reference threshold value, the work setting unit 62 assigns a next work preset for the mobile body 10 to the mobile body 10 as the next work, and outputs a command to execute the next work to the mobile body 10. Upon acquisition of the command to execute the next work, the mobile body 10 starts the next work. That is, when the charge amount at the end of a work is equal to or greater than the reference threshold value, the mobile body 10 executes a predetermined next work as scheduled. In the example of FIG. 7, when the charge amount of the mobile body 10A that has completed a work related to the target object P1 is equal to or greater than the reference threshold value, the work setting unit 62 outputs a command to execute a work of conveying a target object P2 to the mobile body 10A. The mobile body 10A executes the work of conveying the target object P2 during a reserved time period for the work. Note that, when there is no preset next work, no next work needs to be executed.

Charge Amount Less than Reference Threshold Value

When the charge amount of the mobile body 10 that has completed one work is less than the reference threshold value, the information processing device 14 causes the scheduled work acquisition unit 66 to acquire information on a scheduled work that is a work scheduled in the future. In the first embodiment, the scheduled work acquisition unit 66 acquires the information on the scheduled work for the mobile body 10 to which a next work is assigned. Since the works of the mobile body 10 are set in advance by the work setting unit 62, the scheduled work acquisition unit 66 acquires information on a work of the mobile body 10 that is scheduled after the completed work as the information on the scheduled work. That is, in the example of FIG. 7, when the charge amount of the mobile body 10A that has completed the work related to the target object P1 is less than the reference threshold value, the scheduled work acquisition unit 66 acquires information on the work related to the target object P2 assigned to the mobile body 10A as the information on the scheduled work.

The work setting unit 62 calculates an estimated charge amount for the scheduled work based on the information on the scheduled work of the mobile body 10. The estimated charge amount refers to an estimated value of the charge amount (remaining amount of stored electric power) of the mobile body 10 in a case where the mobile body 10 moves to a charging point after executing at least a part of the scheduled work. More specifically, the estimated charge amount in the present embodiment refers to an estimated value of the charge amount of the mobile body 10 in a case where the mobile body 10 moves to a charging point after completing a scheduled work. Power consumption for the movement to a charging point after the completion of a scheduled work depends on, for example, the route R for the scheduled work, and the position of the charging point. Accordingly, the work setting unit 62 can calculate an estimated power consumption for the scheduled work based on the charge amount of the mobile body 10 at the end of a work, the information on the scheduled work, and the position information of the charging point. That is, the work setting unit 62 can calculate the estimated charge amount for the scheduled work by subtracting the estimated power consumption required for the execution of the scheduled work and the movement to the charging point from the charge amount of the mobile body 10 at the end of the work. For example, in the example of FIG. 7, the work setting unit 62 acquires a first estimated power consumption that is an estimated power consumption of the mobile body 10A in a case of moving from a position A2 (the initial position) to a position A31 (the first position of the scheduled work of conveying the target object P2). Further, the work setting unit 62 acquires a second estimated power consumption that is an estimated power consumption of the mobile body 10A in a case of moving from the position A31 (the first position of the scheduled work of conveying the target object P2) to a position A5 (the second position of the scheduled work of conveying the target object P2). Furthermore, the work setting unit 62 acquires a third estimated power consumption that is an estimated power consumption of the mobile body 10A in a case of moving from the position A5 (the second position of the scheduled work of conveying the target object P2) to the charging point. The work setting unit 62 calculates a value obtained by subtracting the sum of the first estimated power consumption, the second estimated power consumption, and the third estimated power consumption from the charge amount of the mobile body 10A that has completed the work of conveying the target object P1, as the estimated charge amount for the scheduled work of conveying the target object P2.

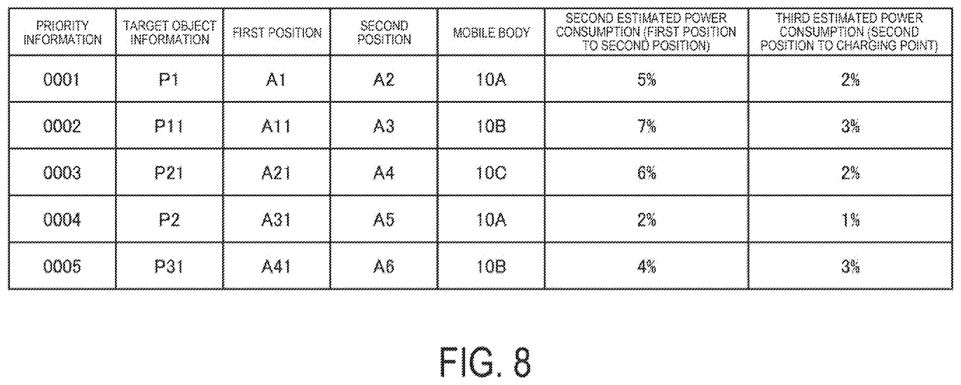

FIG. 8 is a table showing an example in which the estimated power consumption is set in advance. The work setting unit 62 may acquire the estimated power consumption in any manner. For example, as illustrated in FIG. 8, the estimated power consumption may be set in advance for each work. That is, since power consumption depends on the route R for a scheduled work and the position of a charging point, the estimated power consumption can be calculated in advance. In that case, the work setting unit 62 reads the estimated power consumption set for a scheduled work from among the estimated power consumption set for each work, and calculates a value obtained by subtracting the estimated power consumption that has been read out from the charge amount of the mobile body 10 as the estimated charge amount for the scheduled work. In FIG. 8, although the first estimated power consumption for moving from the initial position to the first position is not described, the initial position can be determined in advance as a position at which the previous work is completed, and thus the first estimated power consumption can also be set in advance. Note that, when there is a plurality of charging points, the estimated power consumption may be set for each charging point.

In addition, the estimated power consumption is not limited to being set in advance, and the work setting unit 62 may calculate the estimated power consumption when determining a next work. In that case, the work setting unit 62 calculates the estimated power consumption based on the position information of the initial position, the route R (the first position and the second position) for a scheduled work, and a charging point. That is, for example, an estimated value of power consumption per unit distance (unit power consumption) may be set in advance, and the work setting unit 62 may calculate the first estimated power consumption based on the distance from the initial position to the first position and the unit power consumption, may calculate the second estimated power consumption based on the distance from the first position to the second position and the unit power consumption, and may calculate the third estimated power consumption based on the distance from the second position to the charging point and the unit power consumption. Note that, when there is a plurality of charging points, the estimated power consumption may be calculated for each charging point.

The work setting unit 62 sets the next work of the mobile body 10 based on the estimated charge amount for a scheduled work. Specifically, when the estimated charge amount for a scheduled work is equal to or greater than the limit threshold value, the work setting unit 62 assigns the scheduled work as the next work of the mobile body 10, and outputs a command to execute the scheduled work to the mobile body 10. Upon acquisition of the command to execute the scheduled work, the mobile body 10 starts the scheduled work. That is, in a case where the charge amount is equal to or greater than the limit threshold value even when the mobile body 10 moves to the charging point after executing the scheduled work, it is determined that executing the scheduled work causes no problem even if the charge amount is currently less than the reference threshold value, and the scheduled work is executed. In the example of FIG. 8, for example, in a case where the reference threshold value is 15%, the limit threshold value is 5%, the first estimated power consumption, the second estimated power consumption, and the third estimated power consumption for the target object P2 are respectively 1%, 2% and 1%, and the charge amount of the mobile body 10A that has completed the work related to the target object P1 is 10%, the estimated charge amount is 6% that is greater than the limit threshold value. Thus, the mobile body 10A executes the scheduled work of conveying the target object P2 as the next work.

On the other hand, when the estimated charge amount for a scheduled work is less than the limit threshold value, the work setting unit 62 assigns a work of moving to a charging point as the next work of the mobile body 10, and outputs a command to execute the work of moving to the charging point to the mobile body 10. In this case, the work setting unit 62 sets a route from the initial position of the mobile body 10 (a position at which the work is completed) to the charging point, and outputs a command to move along the route to the mobile body 10. Upon acquisition of the command, the mobile body 10 moves to the charging point along the route so as to be charged. That is, in the example of FIG. 8, for example, when the charge amount of the mobile body 10A that has completed the work related to the target object P1 is 8%, the estimated charge amount is 4% that is less than the limit threshold value, and thus the mobile body 10A executes the movement to the charging point as the next work.

Note that, in the above description, the scheduled work refers to the work (the work related to the target object P2 in the example of FIG. 8) that is scheduled immediately subsequent to the completed work (the work related to the target object P1 in the example of FIG. 8), but is not limited thereto, and the scheduled work may be any work that is scheduled after the completed work. For example, there may be a plurality of scheduled works. In that case, for example, when the estimated charge amount for an immediately-subsequent scheduled work (the work related to the target object P2) is equal to or greater than the limit threshold value, the work setting unit 62 set the immediately-subsequent scheduled work (the work related to the target object P2) as the next work of the mobile body 10A. On the other hand, when the estimated charge amount for the immediately-subsequent work is less than the limit threshold value and when there is a scheduled work for which the estimated charge amount is equal to or greater than the limit threshold value among other scheduled works, the work setting unit 62 may set the scheduled work for which the estimated charge amount is equal to or greater than the limit threshold value as the next work of the mobile body 10A. That is, when there is a scheduled work for which the estimated charge amount is equal to or greater than the limit threshold value among the plurality of scheduled works, the work setting unit 62 may set the work for which the estimated charge amount is equal to or greater than the limit threshold value as the next work. On the other hand, when there is no scheduled work for which the estimated charge amount is equal to or greater than the limit threshold value among the plurality of scheduled works, the work setting unit 62 may set the movement to a charging point as the next work. Note that, when there is a plurality of scheduled works for which the estimated charge amount is equal to or greater than the limit threshold value, it is preferable that the work setting unit 62 sets, as the next work, a scheduled work that is the first to be started, that is, a scheduled work having the highest priority in the priority information.

### Processing Flow

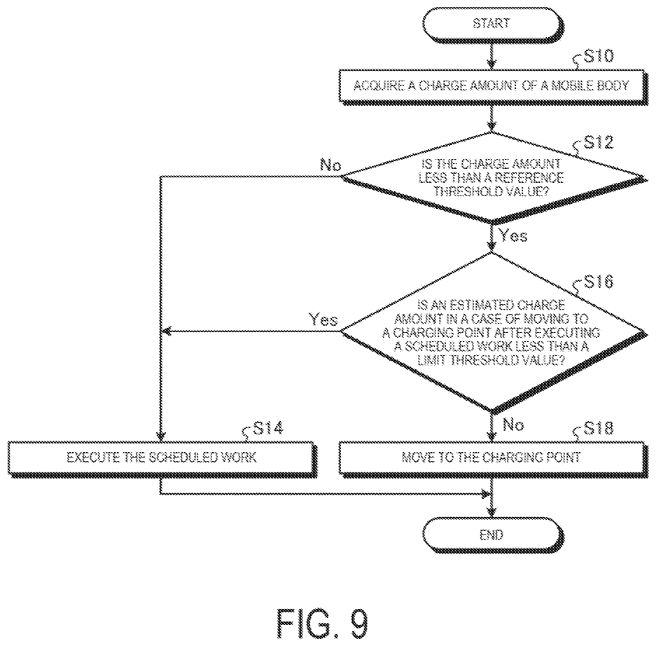

The above-described flow for setting a next work will be described below. FIG. 9 is a flowchart illustrating a flow for setting a next work according to the first embodiment. As illustrated in FIG. 9, the information processing device 14 causes the charge amount acquisition unit 64 to acquire the charge amount of the mobile body 10 (step S10). The information processing device 14 causes the work setting unit 62 to determine whether or not the charge amount of the mobile body 10 is less than the reference threshold value (step S12), and when the charge amount is not less than the reference threshold value (step S12; No), causes the mobile body 10 to execute an immediately-subsequent scheduled work as the next work (step S14). On the other hand, when the charge amount of the mobile body 10 is less than the reference threshold value (step S12: Yes), the information processing device 14 causes the work setting unit 62 to determine whether or not the estimated charge amount for the scheduled work is equal to or greater than the limit threshold value (step S16). When the estimated charge amount is equal to or greater than the limit threshold value (step S16: Yes), the work setting unit 62 causes the mobile body 10 to execute the scheduled work as the next work (step S14). On the other hand, when the estimated charge amount is not equal to or greater than the limit threshold value (step S16: No), the work setting unit 62 causes the mobile body 10 to execute a work of moving to a charging point as the next work (step S18).

In this manner, in the present embodiment, the next work of the mobile body 10 is determined based on the charge amount of the mobile body 10 and the content of the scheduled work. This makes it possible to determine whether the mobile body 10 executes the scheduled work or is charged in consideration of the charge amount and the scheduled work, and thus reduction in the operating ratio of the mobile body 10 can be suppressed. Further, in the present embodiment, even in a case where the charge amount is less than the reference threshold value, when the estimated charge amount after the execution of a scheduled work is equal to or greater than the limit threshold value, the scheduled work is executed without proceeding to charging. Accordingly, for example, when there is a scheduled work in which power consumption is small, the scheduled work can be executed before proceeding to charging. Thus, the reduction in the operating ratio of the mobile body 10 can be suppressed.

In the above description, the information processing device 14 sets the next work of the mobile body 10, but the disclosure is not limited thereto, and the mobile body 10 may set the next work. That is, the function of setting the next work of the mobile body 10 by the work setting unit 62, the charge amount acquisition unit 64 and the scheduled work acquisition unit 66 of the information processing device 14 may be provided in the control device 28 of the mobile body 10.

### Second Embodiment

Next, a second embodiment will be described. The second embodiment differs from the first embodiment in that a scheduled work of another mobile body 10 is assigned as a next work. In the second embodiment, the description of parts having the same configuration as those in the first embodiment will be omitted.

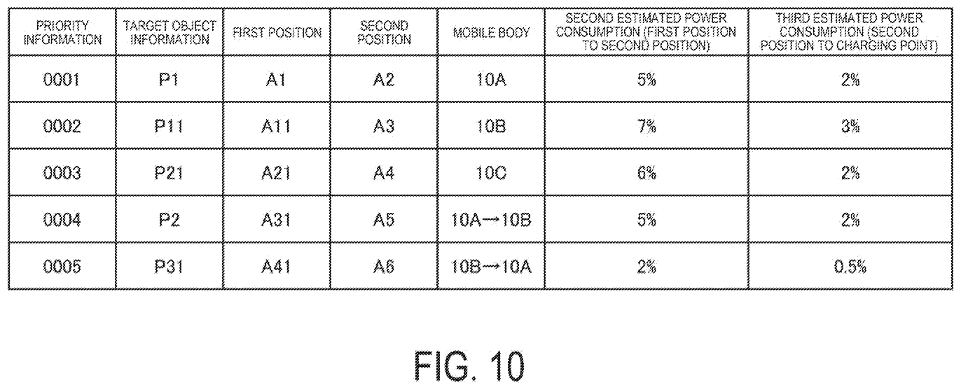

FIG. 10 is a table showing an example of setting a next work according to the second embodiment. In the second embodiment, the scheduled work acquisition unit 66 acquires the information on the scheduled work of a mobile body 10 other than a mobile body 10 which has completed one work and to which a next work is to be set. Hereinafter, the mobile body 10 to which a next work is to be set is referred to as a first mobile body, and a mobile body 10 other than the first mobile body is referred to as a second mobile body. That is, in the second embodiment, the scheduled work acquisition unit 66 acquires the information on the scheduled work of the second mobile body. The scheduled work acquisition unit 66 acquires information on a work of the second mobile body that is scheduled after a completed work of the first mobile body as the information on the scheduled work. The work setting unit 62 of the second embodiment sets the next work of the first mobile body based on the estimated charge amount for the scheduled work of the second mobile body.

Specifically, when the charge amount of the first mobile body is less than the reference threshold value, the work setting unit 62 of the second embodiment determines whether or not the estimated charge amount for a scheduled work of the first mobile body is less than the limit threshold value, similarly to the first embodiment. When the estimated charge amount for the scheduled work of the first mobile body is equal to or greater than the limit threshold value, the work setting unit 62 assigns the scheduled work as the next work of the first mobile body. On the other hand, when the estimated charge amount for a scheduled work of the first mobile body is less than the limit threshold value (when there is no scheduled work of the first mobile body for which the estimated charge amount is equal to or greater than the limit threshold value), the work setting unit 62 acquires the estimated charge amount for a scheduled work of the second mobile body. The method of acquiring the estimated charge amount for a scheduled work of the second mobile body is the same as the method of acquiring the estimated charge amount for a scheduled work of the first mobile body described in the first embodiment.

In a case where the charge amount of the first mobile body is less than the reference threshold value, there is no scheduled work assigned to the first mobile body for which the estimated charge amount is equal to or greater than the limit threshold value, and the estimated charge amount for the scheduled work of the second mobile body is equal to or greater than the limit threshold value, the work setting unit 62 sets such scheduled work of the second mobile body as the next work of the first mobile body, and outputs a command to execute such scheduled work to the first mobile body. Upon acquisition of the command to execute such scheduled work, the first mobile body starts such scheduled work. In this case, the work setting unit 62 assigns the scheduled work of the first mobile body to the second mobile body to which such scheduled work is originally assigned, and outputs a command to execute the scheduled work of the first mobile body to the second mobile body. That is, even in a case where the first mobile body cannot execute a scheduled work assigned to the first mobile body, if the first mobile body can execute a scheduled work of the second mobile body, the work setting unit 62 replace the scheduled work of the first mobile body with the scheduled work of the second mobile body.

On the other hand, when the estimated charge amount for the scheduled work of the second mobile body is less than the limit threshold value, the work setting unit 62 assigns a work of moving to a charging point as the next work of the first mobile body, and outputs a command to execute the work of moving to the charging point to the first mobile body.

In addition, for example, when there is a plurality of scheduled works of the second mobile body, the work setting unit 62 determines whether or not the estimated charge amount is equal to or greater than the limit threshold value for each of the scheduled works of the second mobile body. When there is a scheduled work for which the estimated charge amount is equal to or greater than the limit threshold value among the plurality of scheduled works of the second mobile body, the work setting unit 62 may set the scheduled work of the second mobile body for which the estimated charge amount is equal to or greater than the limit threshold value as the next work of the first mobile body. On the other hand, when there is no scheduled work for which the estimated charge amount is equal to or greater than the limit threshold value among the plurality of scheduled works of the second mobile body, the work setting unit 62 may set the movement to a charging point as the next work of the first mobile body. Note that, when there is a plurality of scheduled works of the second mobile body for which the estimated charge amount is equal to or greater than the limit threshold value, it is preferable that the work setting unit 62 sets, as the next work of the first mobile body, a scheduled work that is the first to be started, that is, a scheduled work having the highest priority in the priority information.

In FIG. 10, an example is shown in which the reference threshold value is 15%, the limit threshold value is 5%, the first estimated power consumption, the second estimated power consumption, and the third estimated power consumption each related to the target object P2 are respectively 1%, 5% and 2%, and the charge amount of the mobile body 10A (the first mobile body) that has completed the work related to the target object P1 is 10%. In this case, the estimated charge amount for a scheduled work related to the target object P assigned to the mobile body 10A is 2% that is less than the limit threshold value. On the other hand, when the first estimated power consumption, the second estimated power consumption, and the third estimated power consumption each related to the target object P31, which is the target object of a scheduled work of the mobile body 10B (the second mobile body), are respectively 1%, 2% and 0.5%, the estimated charge amount for the scheduled work related to the target object P31 of the mobile body 10B is 6.5% that is greater than the limit threshold value. Thus, in this example, the work setting unit 62 assigns the work related to the target object P31 as the next work of the mobile body 10A, and assigns the work related to the target object P2 to the mobile body 10B. The mobile body 10A moves from the position A2 (the initial position) to the position A41 (the first position) and picks up the target object P31, and then moves from the position A41 to the position A6 (the second position) and drops the target object P31, as the next work. Note that, in the example of FIG. 10, although a work related to a target object P21 of a mobile body 10C (the second mobile body) has a higher priority than the work related to the target object P31, the estimated charge amount for the work related to the target object P21 is less than the limit threshold value, and thus the work related to the target object P21 is not assigned to the mobile body 10A as the next work.

Note that, in the above description, when there is a plurality of scheduled works of the second mobile body for which the estimated charge amount is equal to or greater than the limit threshold value, a scheduled work having the highest priority is set as the work of the first mobile body, but the disclosure is not limited thereto. For example, when there is a plurality of scheduled works of the second mobile body for which the estimated charge amount is equal to or greater than the limit threshold value, the work setting unit 62 may assign, to the first mobile body, a scheduled work whose first position is located close to the initial position of the first mobile body among such scheduled works of the second mobile body. That is, for example, when there is a plurality of scheduled works of the second mobile body for which the estimated charge amount is equal to or greater than the limit threshold value, it is preferable that the work setting unit 62 sets a scheduled work whose first position is located within a predetermined distance range from a route from the initial position of the first mobile body to a charging point (charging route) as the next work of the first mobile body. Further, when there is a plurality of scheduled works of the second mobile body whose first position is located within a predetermined distance range from the charging route of the first mobile body, the work setting unit 62 may set a scheduled work whose first position is located closest to the charging route as the next work of the first mobile body. In addition, for example, when there is a plurality of scheduled works of the second mobile body for which the estimated charge amount is equal to or greater than the limit threshold value, the work setting unit 62 may set the next work of the first mobile body based on the distance from the initial position of the second mobile body (a position at which an immediately preceding work is completed) to the first position of a scheduled work of the second mobile body. For example, the work setting unit 62 may set a scheduled work for which the distance from the initial position of the second mobile body to the first position of the scheduled work is longest as the next work of the first mobile body. That is, the first mobile body may execute, in substitution for the second mobile body, a scheduled work of the second mobile body in which the workload of the second mobile body is high because the second mobile body is far away from the loading point of the scheduled work. Alternatively, when there is a plurality of scheduled works of the second mobile body for which the estimated charge amount is equal to or greater than the limit threshold value, the work setting unit 62 may, by using the above-described processes in combination, set the next work of the first mobile body based on the priority order, the distance between a charging route and the first position of a scheduled work, and the distance from the initial position of the second mobile body to the first position of the scheduled work.

In this manner, in the second embodiment, even in a case where the first mobile body cannot execute a scheduled work assigned to the first mobile body, if the first mobile body can afford to execute a scheduled work of the second mobile body, the first mobile body is caused to execute the scheduled work of the second mobile body. Accordingly, the reduction in the operating ratio of the mobile body 10 can be suppressed.

### Third Embodiment

Next, a third embodiment will be described. The third embodiment differs from the second embodiment in that the first mobile body execute only a part of a scheduled work of the second mobile body. In the third embodiment, descriptions of the same processes as in the second embodiment will be omitted.

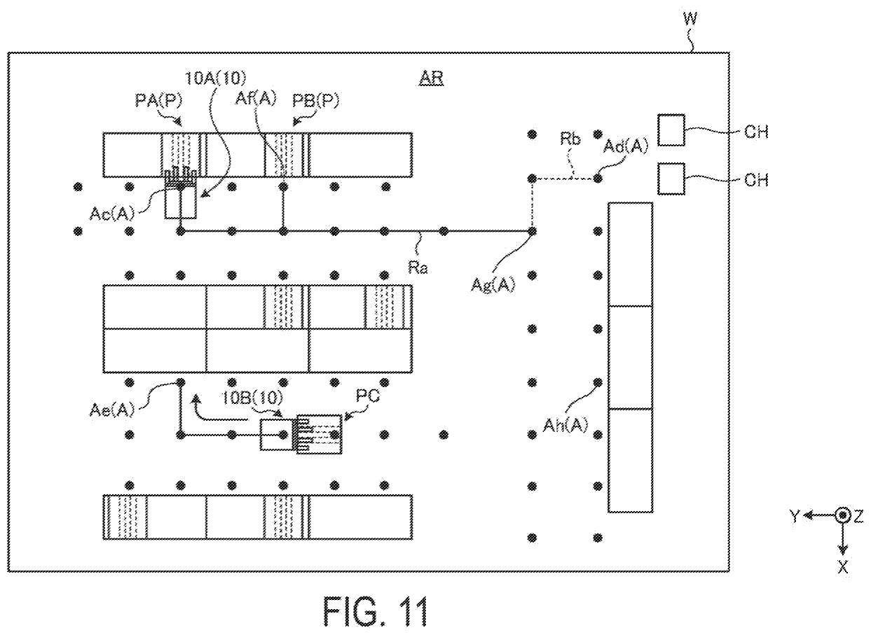

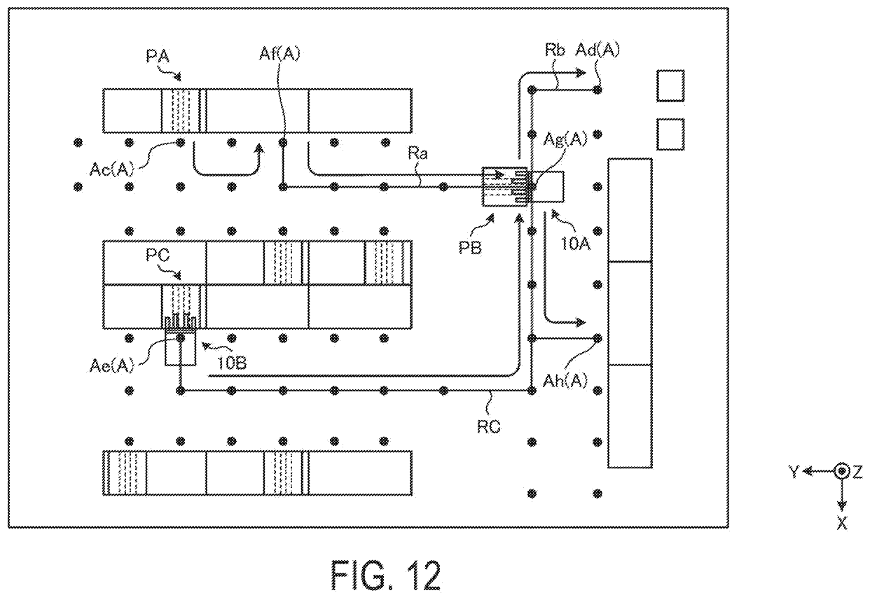

Each of FIGS. 11 and 12 is a schematic view illustrating an example of dropping a target object at an intermediate position. In the second embodiment, the first mobile body executes the entirety of a scheduled work of the second mobile body that is set as the next work. However, in the third embodiment, the first mobile body executes only a part of a scheduled work of the second mobile body that is set as the next work. Specifically, the first mobile body conveys a target object P, not to the second position of the scheduled work, but to an intermediate position located on the second position side of the first position of the scheduled work, and drops the target object P at the intermediate position.

Specifically, in the third embodiment, the work setting unit 62 sets a route from the initial position of the first mobile body to the first position of the scheduled work of the second mobile body and a route from the first position to the intermediate position as the next work of the first mobile body, and transmits the set routes to the first mobile body as the information on the next work. Accordingly, the first mobile body moves from the initial position to the first position of the scheduled work of the second mobile body and picks up the target object P, and then moves to the intermediate position and drops the target object P. Note that it is preferable that the work setting unit 62 sets, for the first mobile body, a work of moving to a charging point as a work that follows the work of dropping the target object P at the intermediate position. That is, after the work of dropping the target object P at the intermediate position, the work setting unit 62 sets a route from the intermediate position to the charging point, and transmits the route to the first mobile body. After dropping the target object P at the intermediate position, the first mobile body moves from the intermediate position to the charging point so as to be charged. FIG. 11 is an example of setting the next work of the mobile body 10A (the first mobile body) that has dropped a target object P1 at a position Ac. In the example of FIG. 11, as for the mobile body 10A located at the position Ac, although the estimated charge amount for a scheduled work of the mobile body 10A is less than the limit threshold value, the estimated charge amount for a work of conveying a target object PB that is a scheduled work of the mobile body 10B is equal to or greater than the limit threshold value. Thus, the work setting unit 62 sets the work of conveying the target object PB as the next work of the mobile body 10A, and sets a route from the position Ac (initial position) to a position Af (first position of the target object PB) and a route from the position Af to a position Ag (intermediate position) as a route Ra for the next work of the mobile body 10A. As illustrated in FIG. 12, the mobile body 10A moves from the position Ac to the position Af and picks up the target object PB, and then moves to the position Ag and drops the target object PB. Further, the work setting unit 62 sets a route Rb from the position Ag to a position Ad (charging point) as the next work. Thus, after dropping the target object PB at the position Ag, the mobile body 10A moves to the position Ad so as to be charged.

In addition, the work setting unit 62 causes the second mobile body to take over a work of conveying the target object P dropped at the intermediate position by the first mobile body to the second position. That is, the work setting unit 62 sets a route from the initial position of the second mobile body to the intermediate position and a route from the intermediate position to the second position of the target object P as a scheduled work of the second mobile body, and transmits the scheduled work to the second mobile body. Accordingly, the second mobile body moves from the initial position to the intermediate position and picks up the target object P, and then moves to the second position and drops the target object P. In the examples of FIGS. 11 and 12, the work of conveying the target object PB is set as the scheduled work of the mobile body 10B (second mobile body) for which a work of conveying a target object PC to a position Ae is originally set. The work setting unit 62 resets a work of taking over the conveyance of the target object PB as the scheduled work of the mobile body 10B. That is, as illustrated in FIG. 12, the work setting unit 62 sets a route from the position Ae (initial position) to the position Ag (intermediate position) and a route from the position Ag to a position Ah (second position of the target object PB) as the scheduled work of the mobile body 10B. The mobile body 10B moves from the position Ae to the position Ag and picks up the target object PB, and then moves to the position Ah and drops the target object PB.

Note that the second mobile body that takes over the work of conveying the target object P is preferably a mobile body 10 for which the work of conveying the target object P is originally set, but is not limited thereto, and another mobile body 10 for which the work of conveying the target object P is not set may be the second mobile body that takes over the work. That is, in the example of FIG. 12, a mobile body 10 other than the mobile bodies 10A and 10B may convey the target object PB from the position Ag to the position Ah.

The intermediate position at which the target object P is dropped may be set arbitrarily. For example, the work setting unit 62 may set the intermediate position based on a position at which the charging route that is a route from the initial position of the first mobile body to a charging point and a conveyance route that is a route from the first position to the second position of the target object P branch off from each other (branch point). For example, the work setting unit 62 may set a branch point (waypoint A of the branch point) itself as the intermediate position. In the example of FIG. 12, the position Ag is the branch point between the charging route from the position Ac to the position Ad and the conveyance route from the position Af to the position Ah, and thus the position Ag is set as the intermediate position. However, the disclosure is not limited thereto, the work setting unit 62 may set a position (waypoint) located within a predetermined distance range from a branch point as the intermediate position. In that case, for example, the work setting unit 62 may set a charging point or a waiting point that is located within a predetermined distance range from the branch point as the intermediate position. In addition, for example, the work setting unit 62 may set, as the intermediate position, a waypoint that is located within a predetermined distance range from the branch point and faces a placement area AR1 with no target object P placed.

Similarly to the second embodiment, when the estimated charge amount for a scheduled work of the second mobile body is equal to or greater than the limit threshold value, the work setting unit 62 of the third embodiment sets the scheduled work of the second mobile body as the next work of the first mobile body. Here, the estimated charge amount in the second embodiment refers to an estimated value of the charge amount in a case of moving to a charging point after completing the entirety of the scheduled work of the second mobile body. That is, in the example of FIG. 12, the estimated charge amount is an estimated value of the charge amount in a case where the mobile body 10 picks up the target object PB at the position Af, drops the target object PB at the position Ah, and then moves to the position Ad. However, in the third embodiment, since the target object P is conveyed only to the intermediate position, it is not necessary to determine the estimated charge amount on the assumption that the entirety of the scheduled work of the second mobile body is completed. In the third embodiment, for example, the work setting unit 62 may calculate an estimated value of the charge amount in a case of moving to a charging point after executing only a part of a scheduled work of the second mobile body, as the estimated charge amount for the scheduled work of the second mobile body. That is, in the example of FIG. 12, the estimated charge amount may be an estimated value of the charge amount in a case where the mobile body 10 picks up the target object PB at the position Af, drops the target object PB at the position Ag (intermediate position), and then moves to the position Ad. In that case, for example, the work setting unit 62 may select, as the intermediate position, such a position that the estimated charge amount is equal to or greater than the limit threshold value in a case of dropping at that position and then moving to a charging position, from among positions (waypoints A) that are candidates for the intermediate position.

In addition, when there is a plurality of scheduled works of the second mobile body, the work setting unit 62 of the third embodiment may select a scheduled work to be set as the next work of the first mobile body in the same manner as in the second embodiment.

In this manner, in the third embodiment, even in a case where the first mobile body cannot execute a scheduled work of the first mobile body, if the first mobile body can afford to execute a part of a scheduled work of the second mobile body, the first mobile body is caused to execute the part of the scheduled work of the second mobile body. Accordingly, the reduction in the operating ratio of the mobile body 10 can be suppressed.

Note that, in the third embodiment, the first mobile body executes a part of a scheduled work of the second mobile body, but the disclosure is not limited thereto, and the first mobile body may execute a part of a scheduled work of the first mobile body. That is, when the first mobile body cannot execute the entirety of a scheduled work, but can execute only a part of the scheduled work, the first mobile body may execute only the part of the scheduled work of the first mobile body. The method of setting a part of the work of the first mobile body is the same as that of the second mobile body, and thus the description thereof is omitted.

### Fourth Embodiment

Next, a fourth embodiment will be described. The fourth embodiment differs from the first embodiment in that the reference threshold value is set based on the charge amount and a scheduled work of the mobile body 10. In the fourth embodiment, the description of parts having the same configuration as those in the first embodiment will be omitted. Note that the fourth embodiment can also be applied to the second embodiment and the third embodiment.

### Acquisition of Charge Amount

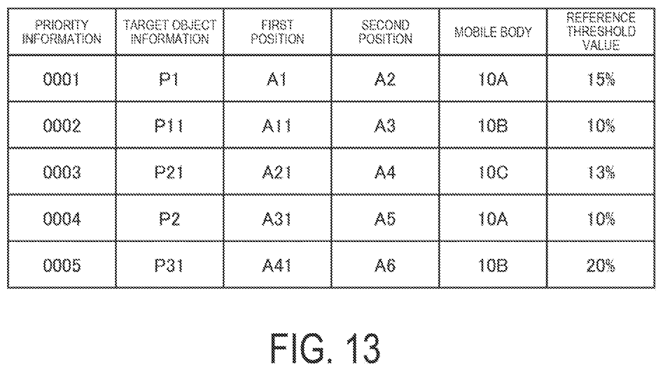

FIG. 13 is a table showing an example of setting a reference threshold value. The charge amount detection unit 84 of a mobile body 10 detects the charge amount of the mobile body 10. The charge amount detection unit 84 transmits information on the charge amount detected to the information processing device 14. The charge amount acquisition unit 64 of the information processing device 14 acquires the information on the charge amount of the mobile body 10 from the mobile body 10. In the present embodiment, the charge amount acquisition unit 64 acquires the charge amount of a mobile body 10 that has completed one work. In FIG. 13, for example, the charge amount acquisition unit 64 of the information processing device 14 acquires the charge amount of a mobile body 10A from the mobile body 10A in a state in which the mobile body 10A is located at a second position A2 after having dropped a target object P1 at the second position A2.

### Acquisition of Scheduled Work

The scheduled work acquisition unit 66 acquires information on a scheduled work of the mobile body 10.

### Setting of Reference Threshold Value

The work setting unit 62 sets a reference threshold value for the mobile body 10 based on the charge amount and the information on the scheduled work of the mobile body 10. That is, the work setting unit 62 sets the reference threshold value for the mobile body 10 at that time based on the charge amount of the mobile body 10 that has completed one work and the content of a subsequently-scheduled work. That is, as illustrated in FIG. 13, the work setting unit 62 acquires the charge amount and the information on the scheduled work of the mobile body 10 every time the mobile body 10 completes a work, and sets a reference threshold value at the time of completion of the work for each work. Note that the reference threshold value in FIG. 13 is an example.

Preferably, the work setting unit 62 sets the reference threshold value such that time periods during which at least two mobile bodies 10 are charged do not overlap with each other. For example, at the timing when a mobile body 10 completes a work, the work setting unit 62 determines whether or not another mobile body 10 is being charged. Since the work setting unit 62 acquires the position information of the mobile body 10 from each mobile body 10 on a timely basis, the work setting unit 62 determines whether or not another mobile body 10 is located at a charging point based on the position information of the another mobile body 10 at the timing when the mobile body 10 completes the work. The work setting unit 62 determines that the another mobile body 10 is being charged when another mobile body 10 is present at the charging point at the timing when the mobile body 10 completes the work. When another mobile body 10 is not being charged, the work setting unit 62 uses a preset reference threshold value. On the other hand, when another mobile body 10 is being charged, the work setting unit 62 sets the reference threshold value to be lower than the charge amount of the mobile body 10 that has completed the work. Accordingly, the current charge amount of the mobile body 10 is greater than the reference threshold value, that is, the charge amount of the mobile body 10 does not become less than the reference threshold value and thus the mobile body 10 can be prevented from moving to the charging point in the time period during which another mobile body 10 is being charged. Note that the work setting unit 62 may set the reference threshold value to be equal to or greater than a predetermined lower limit value. In that case, for example, the work setting unit 62 acquires the estimated power consumption that is an estimated value of power consumption for moving from a position at which a work is completed to a charging point. The work setting unit 62 sets a value obtained by adding the estimated power consumption and the limit threshold value as the lower limit value, and set the reference threshold value to be equal to or greater than the lower limit value. That is, when the charge amount of the mobile body 10 that has completed a work is less than the lower limit value, the reference threshold value is not set to be less than the charge amount of the mobile body 10 that has completed the work, but is set to be equal to or greater than the lower limit value. Accordingly, it is possible to prevent the mobile body 10 from running out of charge due to executing the next work. In addition, the work setting unit 62 may set, for each mobile body 10, the timing at which the mobile body 10 moves from the charging point, that is, the charge amount based on which it is determined that charging of the mobile body 10 has been completed.

In this manner, in the fourth embodiment, the reference threshold value is set based on the charge amount and the scheduled work of the mobile body 10. Furthermore, in the fourth embodiment, it is preferable that the work setting unit 62 sets the reference threshold value such that each mobile body 10 has a different timing at which the charge amount falls below the reference threshold value based on the scheduled work (including a work to be executed several hours later, for example) assigned to each mobile body 10. Accordingly, it is possible to set the reference threshold value for each mobile body 10, and, for example, a plurality of mobile bodies can be prevented from being charged during the same time period, and the reduction in the operating ratio of the mobile body can be suppressed.

Note that, in the fourth embodiment, the next work of the mobile body 10 is set based on the charge amount and the scheduled work similarly to the first to third embodiments, but a process of setting the next work is not essential. That is, in the fourth embodiment, it is only necessary to execute at least a process of setting the reference threshold value for each of the plurality of mobile bodies 10 based on the charge amounts and the scheduled works of the mobile bodies 10.

### Effects of the Disclosure

As described above, the information processing method according to the disclosure includes acquiring information on a charge amount of a mobile body 10, acquiring information on a scheduled work that is a work scheduled to be done, and setting a next work of the mobile body 10 based on the information on the charge amount and the information on the scheduled work. Accordingly, it is possible to determine whether the mobile body 10 executes the scheduled work or is charged in consideration of the charge amount and the scheduled work, and thus the reduction in the operating ratio of the mobile body 10 can be suppressed.

In the setting a next work, when the charge amount is less than a reference threshold value, and when an estimated charge amount of the mobile body 10 in a case where the mobile body 10 moves to a charging point after completing the scheduled work is equal to or greater than a limit threshold value that is lower than the reference threshold value, the scheduled work is set as the next work. On the other hand, in the setting a next work, when the charge amount is less than the reference threshold value, and when the estimated charge amount is less than the limit threshold value, a work of moving to the charging point is set as the next work of the mobile body 10. According to the disclosure, even in a case where the charge amount falls below the reference threshold value, if enough amount is available to execute a subsequent work, the mobile body 10 is caused to execute the subsequent work, and thus the reduction in the operating ratio of the mobile body 10 can be suppressed.

In the acquiring information on a charge amount, a charge amount of a first mobile body is acquired. In the acquiring information on a scheduled work, information on a scheduled work assigned to the first mobile body is acquired. In the setting a next work, when the estimated charge amount for the scheduled work assigned to the first mobile body is equal to or greater than the limit threshold value, the scheduled work is set as the next work of the first mobile body. According to the disclosure, even in a case where the charge amount of the first mobile body falls below the reference threshold value, if enough amount is available to execute a subsequent work assigned to the first mobile body, the mobile body 10 is caused to execute the subsequent work, and thus the reduction in the operating ratio of the mobile body 10 can be suppressed.

In the acquiring information on a scheduled work, information on a scheduled work assigned to a second mobile body is acquired. In the setting a next work, when the estimated charge amount for the scheduled work assigned to the second mobile body is equal to or greater than the limit threshold value, the scheduled work assigned to the second mobile body is set as the next work of the first mobile body. According to the disclosure, even in a case where the charge amount of the first mobile body falls below the reference threshold value, if enough amount is available to execute a subsequent work assigned to the second mobile body, the first mobile body 10 is caused to execute the subsequent work, and thus the reduction in the operating ratio of the mobile body 10 can be suppressed.

The work is a work of causing the mobile body 10 to pick up a target object P located at a conveyance source (first position), convey the target object P to a conveyance destination (second position), and drop the target object P. The information processing method according to the disclosure further includes causing the first mobile body to execute the scheduled work originally assigned to the second mobile body and then set as the next work of the first mobile body. In the causing the first mobile body to execute the scheduled work, the first mobile body is caused to convey the target object P to an intermediate position located on the conveyance destination side of the conveyance source and drop the target object P at the intermediate position. According to the disclosure, even in a case where the charge amount of the first mobile body falls below the reference threshold value, if enough amount is available to execute a part of a work assigned to the second mobile body, the first mobile body is caused to execute the part of the work, and thus the reduction in the operating ratio of the mobile body 10 can be suppressed.

In the causing the first mobile body to execute the scheduled work, the first mobile body is caused to drop the target object P and then move to the charging point. According to the disclosure, since the first mobile body is caused to execute the part of the work and then move to the charging point, it is possible to appropriately charge the first mobile body while suppressing the reduction in the operating ratio of the mobile body 10.

In the causing the first mobile body to execute the scheduled work, a branch point at which a charging route from the conveyance source (first position) to the charging point and a conveyance route from the conveyance source (first position) to the conveyance destination (second position) branch off from each other is set as the intermediate position. According to the disclosure, since the target object P is conveyed to the branch point, the reduction in the operating ratio of the mobile body 10 can be suppressed.

The information processing method according to the disclosure further includes setting a reference threshold value for the charge amount of the mobile body 10 based on the information on the charge amount and information on the scheduled work, and in the setting the next work, the next work is set based on the reference threshold value. According to the disclosure, it is possible to set the reference threshold value for each mobile body 10, and, for example, a plurality of mobile bodies can be prevented from being charged during the same time period, and the reduction in the operating ratio of the mobile body 10 can be suppressed.

In the setting the reference threshold value, the reference threshold value is set such that time periods during which at least two of the mobile bodies 10 are charged do not overlap with each other. According to the disclosure, the plurality of mobile bodies can be prevented from being charged during the same time period, and the reduction in the operating ratio of the mobile body 10 can be suppressed.

The embodiments of the disclosure have been described above, but the embodiment is not limited by the details of the embodiments above. Furthermore, the constituent elements of the above-described embodiments include elements that are able to be easily conceived by a person skilled in the art, and elements that are substantially the same, that is, elements of an equivalent scope. Furthermore, the constituent elements described above can be appropriately combined. Furthermore, it is possible to make various omissions, substitutions, and changes to the constituent elements within a range not departing from the scope of the above-described embodiments.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An information processing method comprising:
acquiring information on a charge amount of a mobile body;
acquiring information on a scheduled work, the scheduled work being a work scheduled to be done; and
setting a next work of the mobile body based on the information on the charge amount and the information on the scheduled work.

2. The information processing method according to claim 1, wherein
in the setting a next work,
when the charge amount is less than a reference threshold value, and when an estimated charge amount of the mobile body in a case where the mobile body moves to a charging point after completing the scheduled work is equal to or greater than a limit threshold value that is lower than the reference threshold value, the scheduled work is set as the next work, and
when the charge amount is less than the reference threshold value, and when the estimated charge amount is less than the limit threshold value, a work of moving to the charging point is set as the next work of the mobile body.

3. The information processing method according to claim 2, wherein
in the acquiring information on a charge amount, a charge amount of a first mobile body is acquired,
in the acquiring information on a scheduled work, information on a scheduled work assigned to the first mobile body is acquired, and
in the setting a next work, when the estimated charge amount for the scheduled work assigned to the first mobile body is equal to or greater than the limit threshold value, the scheduled work is set as the next work of the first mobile body.

4. The information processing method according to claim 3, wherein
in the acquiring information on a scheduled work, information on a scheduled work assigned to a second mobile body is acquired, and
in the setting a next work, when the estimated charge amount for the scheduled work assigned to the second mobile body is equal to or greater than the limit threshold value, the scheduled work assigned to the second mobile body is set as the next work of the first mobile body.

5. The information processing method according to claim 4, further comprising causing the first mobile body to execute the scheduled work originally assigned to the second mobile body and then set as the next work of the first mobile body, the next work being a work of causing the mobile body to pick up a target object located at a conveyance source, convey the target object to a conveyance destination, and drop the target object at the conveyance destination, wherein
in the causing the first mobile body to execute the scheduled work, the first mobile body is caused to convey the target object to an intermediate position located on the conveyance destination side of the conveyance source and drop the target object at the intermediate position.

6. The information processing method according to claim 5, wherein, in the causing the first mobile body to execute the scheduled work, the first mobile body is caused to drop the target object and then move to the charging point.

7. The information processing method according to claim 6, wherein, in the causing the first mobile body to execute the scheduled work, a branch point at which a route from the conveyance source to the charging point and another route from the conveyance source to the conveyance destination branch off from each other is set as the intermediate position.

8. The information processing method according to claim 1, further comprising setting a reference threshold value for the charge amount of the mobile body based on the information on the charge amount and the information on the scheduled work,
wherein, in the setting the next work, the next work is set based on the reference threshold value.

9. The information processing method according to claim 8, wherein, in the setting the reference threshold value, the reference threshold value is set such that time periods during which at least two of the mobile bodies are charged do not overlap with each other.

10. An information processing device comprising:
a charge amount acquisition unit configured to acquire information on a charge amount of a mobile body;
a scheduled work acquisition unit configured to acquire information on a scheduled work, the scheduled work being a work scheduled to be done; and
a work setting unit configured to set a next work of the mobile body based on the information on the charge amount and the information on the scheduled work.

11. A non-transitory computer readable storage medium storing a program for causing a computer to perform processing, the processing comprising:
acquiring information on a charge amount of a mobile body;
acquiring information on a scheduled work, the scheduled work being a work scheduled to be done; and
setting a next work of the mobile body based on the information on the charge amount and the information on the scheduled work.
